(19) United States
(12) Patent Application Publication
(10) Pub. No.: US 2003/0163516 A1
(43) Pub. Date: Aug. 28, 2003

(54) Session coordination

(76) Inventors: Gregory Eugene Perkins, Boise, ID (US); Patrick O?apos;Neil Sandfort, Meridian, ID (US); Shell Sterling Simpson, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/085,679

(22) Filed: Feb. 27, 2002

(51) Int. Cl. G06F 15/16

(52) U.S. Cl. 709/203; 709/230; 709/213

(57) ABSTRACT

A method and system enabling one server to acquire information regarding the activities of a user with regard to a second server requiring minimal user interaction and without requiring user's browser to be extended. A method embodying the invention includes providing a session interface having instructions to send association data, and then identifying activity related to a previously provided session interface utilizing the association data. In various embodiment of the present invention, the session interface will be a web page. Thus, the association data will include a cookie and an URL (Uniform Resource Locator) for the web page. Using the URL for the provided web page, the cookie is acquired. Using the cookie, other association data containing the same cookie is located. The located association data contains the URL of the previously provided session interface or web page in this case. Using that URL, activity relating to the previously provided web page can be identified and utilized in relation to the provided web page.

### FIELD OF THE INVENTION

The present invention is directed to a method and system for coordinating program sessions.

### BACKGROUND OF THE INVENTION

In a basic desktop computing environment, a computer, accessing data from its hard drive, performs a specified function such as word processing, displaying information on a screen, and when requested, producing a document on a connected printer. In a distributed computing environment, the functionality found in the desktop environment is spread across any number of interconnected devices.

For example, a client, in this case a web browser, accesses a document server and selects a document to be produced—sent to a printer, sent via facsimile, or sent via electronic mail. The client then accesses a production server to produce the selected document. The production server acquires the selected document from the document server and produces the document as instructed.

To facilitate the user's requests, the browser, the production server, and the document server utilize HTTP (Hypertext Transport Protocol). HTTP is a “stateless” protocol. That is, web servers responding to requests for web pages using HTTP have no memory of previous requests, nor can they anticipate future requests. Without help, a web server is only cognizant of a request it has just received and is processing. Once the request is processed, the web server, without help, cannot relate that request with and previous or future requests.

Continuing with the example, the document server and production server are in many cases independent of one another. In other words, without being informed, one server does not know what the other server is doing. The production server does not know which document the user selected and must acquire that information from the document server. A difficulty arises because multiple users may be accessing the document server at any given time. The production server, without help, cannot identify which user selected which document.

One solution has been to extend the browser to include programming that provides this information to the production server. However, extending a browser poses some significant hurdles. For example, the user must download and install the programming, and different programming is required for different browser types and versions.

### SUMMARY OF THE INVENTION

Accordingly, the present invention is directed to a method and system enabling one server to acquire information regarding the activities of a user with regard to a second server requiring minimal user interaction and without requiring user's browser to be extended. A method embodying the invention includes providing a session interface having instructions to send association data, and then identifying activity related to a previously provided session interface utilizing the association data. In various embodiment of the present invention, the session interface will be a web page. Thus, the association data will include a cookie and an URL (Uniform Resource Locator) for the web page. Using the URL for the provided web page, the cookie is acquired. Using the cookie, other association data containing the same cookie is located. The located association data contains the URL of the previously provided session interface or web page in this case. Using that URL, activity relating to the previously provided web page can be identified and utilized in relation to the provided web page.

### DESCRIPTION OF THE DRAWINGS

FIG. 1 is a schematic representation of a computer network in which various embodiments of the present invention may be incorporated.

FIG. 2 is a block diagram of the network of FIG. 1 illustrating the logical program components operating on each device according to one embodiment of the present invention.

FIG. 3 is a block diagram logically illustrating an association table according to one embodiment of the present invention.

FIG. 4 is a flow diagram illustrating session coordination according to one embodiment of the present invention.

FIG. 5 is a flow diagram illustrating session coordination relating to the selection and production of an electronic document according to one embodiment of the present invention.

FIG. 6 is an exemplary screen view of an interface provided in accordance with the flow diagram of FIG. 5.

### DETAILED DESCRIPTION OF THE INVENTION

Glossary:

Program: An organized list of electronic instructions that, when executed, causes a device to behave in a predetermined manner. A program can take many forms. For example, it may be software stored on a computer's disk drive. It may be firmware written onto read-only memory. It may be embodied in hardware as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components.

Client-Server: A model of interaction between two programs. For example, a program operating on one network device sends a request to a program operating on another network device and waits for a response. The requesting program is referred to as the “client” while the device on which the client operates is referred to as the “client device.” The responding program is referred to as the “server,” while the device on which the server operates is referred to as the “server device.” The server is responsible for acting on the client request and returning requested information, if any, back to the client. This requested information may be an electronic file such as a word processing document or spread sheet, a web page, or any other electronic data to be displayed or used by the client. In any given network there may be multiple clients and multiple servers. A single device may contain programming allowing it to operate both as a client device and as a server device. Moreover, a client and a server may both operate on the same device.

Web Server: A server that implements HTTP (Hypertext Transport Protocol). A web server can host a web site or a web service. A web site provides a user interface by supplying web pages to a requesting client, in this case a web browser. Web pages can be delivered in a number of formats including, but not limited to, HTML (Hyper-Text Markup Language) and XML (extensible Markup Language). Web pages may be generated on demand using server side scripting technologies including, but not limited to, ASP (Active Server Pages) and JSP (Java Server Pages). A web page is typically accessed through a network address. The network address can take the form of an URL (Uniform Resource Locator), IP (Internet Protocol) address, or any other unique addressing mechanism. A web service provides a programmatic interface which may be exposed using a variety of protocols layered on top of HTTP, such as SOAP (Simple Object Access Protocol).

Data Store: A logical memory area for storing electronic files such as word processor documents, spreadsheets, electronic images such as digital photographs, digital audio and video recordings, computer programs, device drivers, text messages, and any other electronic data. A data store may consist of a single folder located on a media source such as a hard drive, compact flash card, CD ROM, random access memory, or any other structure or mechanism for temporarily or permanently storing electronic data. A data store may consist of multiple folders on a single source or it may include an entire media source. A data store may even span across multiple media sources located on multiple computing devices.

Interface: The junction between a user and a computer program providing commands or menus through which a user communicates with the program. The term user in this context represents generally any individual or mechanism desiring to communicate with the program. A user in many cases is another program. For example, in the client-server model defined above, the server usually generates and delivers to a client an interface for communicating with a program operating on or controlled by the server device. Where the server is a web server, the interface can be a web page from a web site or a programmatic interface from a web service. A web page when displayed by the client device presents a user with controls for selecting options, issuing commands, and entering text. The controls displayed can take many forms. They may include push-buttons, radio buttons, text boxes, scroll bars, or pull-down menus accessible using a keyboard and/or a pointing device such as a mouse connected to a client device. In a non-graphical environment, the controls may include command lines allowing the user to enter textual commands. Where the user is another program, the interface is commonly referred to as a programmatic interface and the controls are logical program elements enabling the user program to provide direction or information.

Session: An instance of the operation of a program under the control of a particular user. For example, a program or application served over the Internet may be accessed by more than one user at one time. Each instance of a user accessing the program is a session. A session interface then is an interface for interacting with a particular program session.

INTRODUCTION: In distributed computing environments, a user employs a client to access and direct a server to perform a specified task. The client then accesses and directs a second server to perform a second task that is dependent, at least in part, on the task specified for the first server. It is expected that various embodiments of the present invention will enable the servers to associate the user (or the client) with the tasks specified. In other words, embodiments of the invention will enable the second server to identify the first server and the tasks performed on behalf of the user.

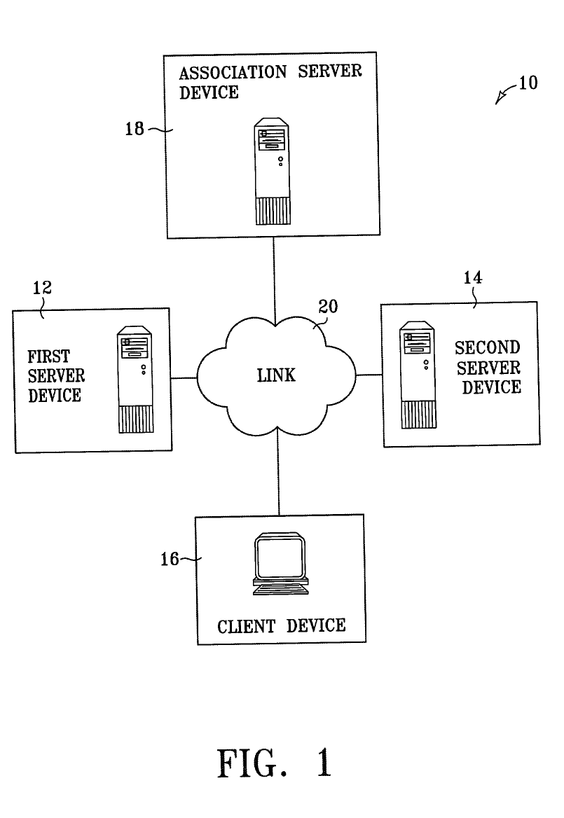

Although the various embodiments of the invention disclosed herein will be described with reference to the computer network 10 shown schematically in FIG. 1, the invention is not limited to use with network 10. The invention may be implemented in or used with any computer system in which it is necessary or desirable to access electronic data. The following description and the drawings illustrate only a few exemplary embodiments of the invention. Other embodiments, forms, and details may be made without departing from the spirit and scope of the invention, which is expressed in the claims that follow this description.

Referring to FIG. 1, computer network 10 represents generally any local or wide area network in which a variety of different electronic devices are linked. Network 10 includes first and second server devices 12 and 14, client device 16, and association server device 18. First and second server devices 12 and 14 contain programming for interacting with and responding to requests from client device 16. Association server device 18 contains programming for enabling first and second server devices 12 and 14 to discover each other in relation to requests made of server devices 12 and 14 by client device 16. While first and second server devices 12 and 14 are illustrated as separate devices, they may in fact be the same device represented at different times.

Link 20 interconnects devices 12-18 and represents generally a cable, wireless, or remote connection via a telecommunication link, an infrared link, a radio frequency link, or any other connector or system that provides electronic communication between devices 12-18. Link 20 may represent an intranet, an Internet, or a combination of both. Devices 12-18 can be connected to the network 10 at any point and the appropriate communication path established logically between the devices.

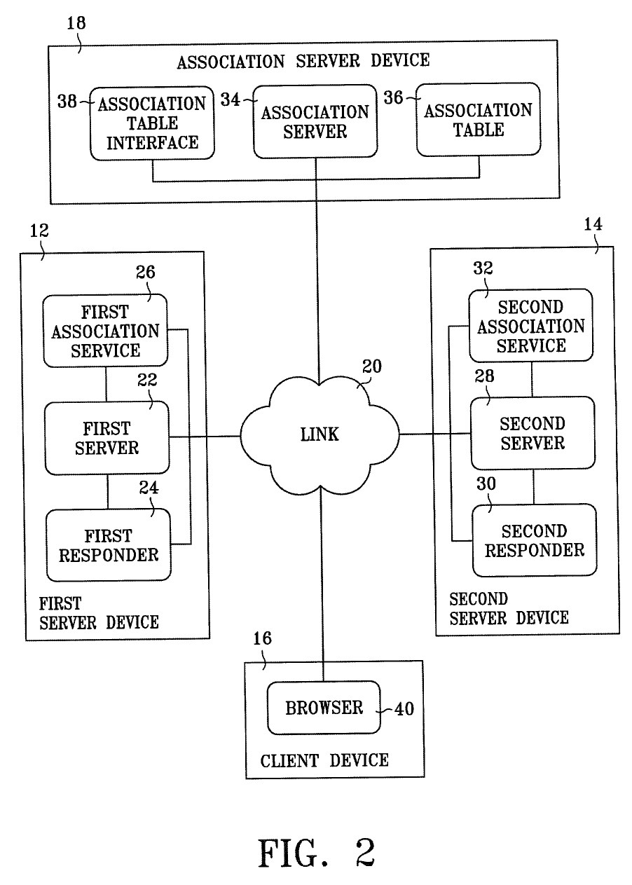

COMPONENTS: The logical components of one embodiment of the server association system will now be described with reference to the block diagram of FIG. 2. First server device 12 includes first server 22, first responder 24, and first association service 26. Similarly, second server device 14 contains second server 28, second responder 30, and second association service 32. Association server device 18 contains association server 34, association table 36, and association table interface 38.

First and second servers 22 and 28 represent generally any programming capable of receiving and returning responses to requests issued by client device 16. First and second responders 24 and 30 represent generally any programming capable of performing specified tasks in response to client device requests received by first and second servers 22 and 28. A response may involve simply generating or supplying a user interface such as a web page, performing a particular task, or a combination of both. A task, for example, may involve instructing a printer to produce a selected document, saving a document to a specified data store, or any of a number of imaginable actions.

First association service 26 represents generally any programming capable of communicating with association server device 18 to discover second server 28 and any actions taken in response to requests second server 28 received from client device 16. Similarly, second association service 32 represents generally any programming capable of communicating with association server device 18 to discover first server 22 and actions taken in response to requests first server 22 received from client device 16.

Association server 34 represents generally any programming capable of receiving and responding to requests made by association services 26 and 32 as well as client device 16. Association server 34 is also responsible for managing association table 36. Association table 36 represents a logical memory area accessible by association table interface 38 and used to contain association data. Association data is data associating a user with a session. In this case one session is established when a user makes a request of first server 22. A second session is established when the user makes a request of second server 28. Association table interface 38 represents programming capable of providing association services 26 and 32 with access to association table 36.

It is expected that servers 22, 28, and 34 will be web servers. First and second responders 24 and 30 then may be web sites, web services, or a combination of the two. Client device 16, then, contains browser 40 capable of communicating with servers 22, 28, and 34.

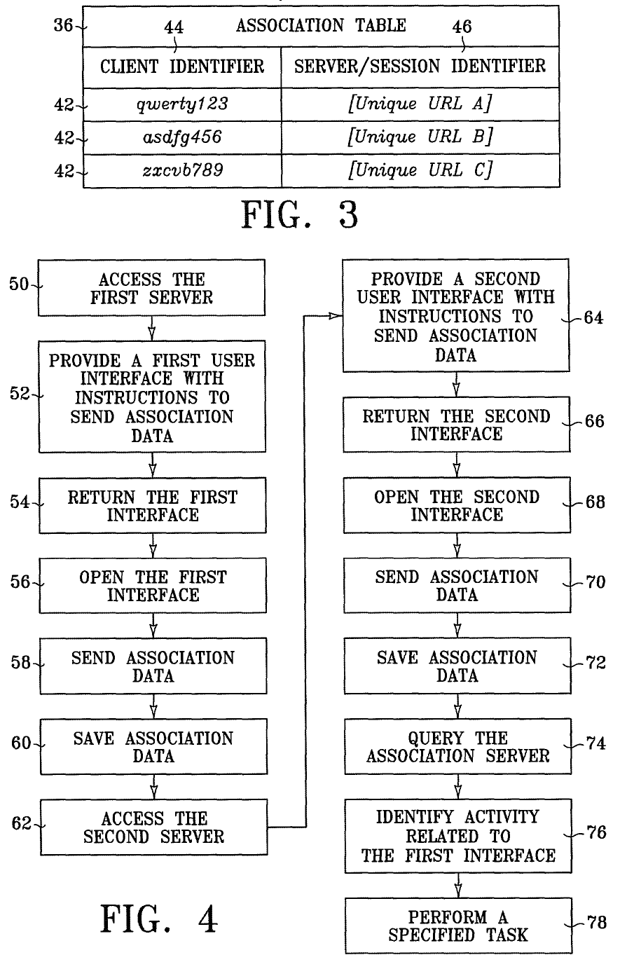

FIG. 3 illustrates the logical elements of association table 36. The exemplary table in FIG. 3 contains three entries 42. Each entry 42 is made up of two fields, a client identifier field 44, and a session identifier field 46. Each time any client device 16 accesses association server 34, server 34 adds an entry to association table 36. In the client identifier field 44 it stores data (client identifier) identifying the client device 16 or user accessing association server 34. In the session identifier field 46, it stores data (session identifier) identifying the first or second server 22 or 28 of which the identified client or user just made a request as well as data identifying the particular session. Where servers 22, 28, and 34 are web servers, a session identifier may be a unique URL (Uniform Resource Locators) identifying a web page produced by first of second server 22 or 28 in response to a request from browser 40. The following is an example of a unique URL: http://www.printservice.com/default?session=123asd. The portion “www.printservice.com” allows browser 40 to access first or second server 22 or 28 depending on which web server the URL refers two. The portion “session=123asd” identifies the particular session or instance of the user accessing the first or second responder 24 or 30 through first or second server 22 or 28.

A client identifier then may be a cookie. A cookie is a message given to a browser by a web server. The browser stores the message in a text file. The message, in many cases, is a simple alphanumeric data string unique to the given browser. The message is then sent back to the server each time the browser sends a request to the web server. Using the cookie, the web server can distinguish the browser from all other browsers making requests of the web server.

The diagrams of FIGS. 2-3 show the architecture, functionality, and operation of one implementation of the present invention. If embodied in software, each block of FIG. 2 may represent a module, segment, or portion of code that comprises one or more executable instructions to implement the specified logical function(s). If embodied in hardware, each block may represent a circuit or a number of interconnected circuits to implement the specified logical function(s).

Also, the present invention can be embodied in any computer-readable medium for use by or in connection with an instruction execution system such as a computer/processor based system or other system that can fetch or obtain the logic from the computer-readable medium and execute the instructions contained therein. A “computer-readable medium” can be any medium that can contain, store, or maintain programs and data for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc.

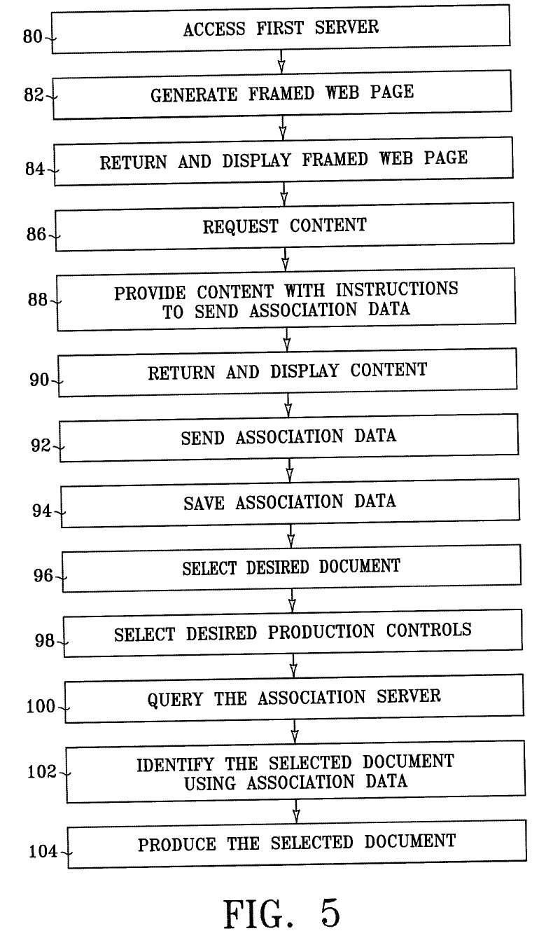

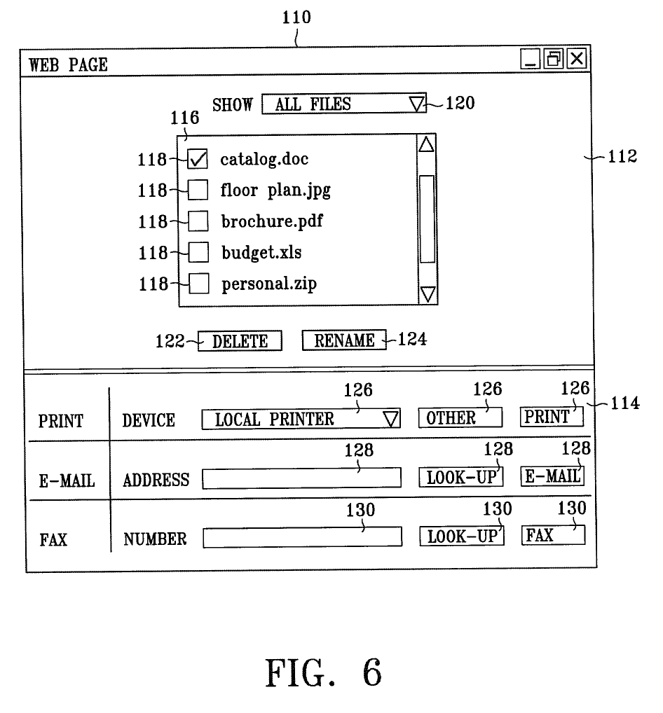

OPERATION: The operation of the invented session coordination method will now be described with reference to the flow diagrams of FIGS. 4 and 5 and the exemplary screen view of FIG. 6. FIG. 4 illustrates, generally, steps taken to coordinate the actions of two servers. Providing a more detailed example, FIG. 5 illustrates steps taken to enable one server to access an electronic document selected by a user and another server to produce that document. FIG. 6 is an exemplary screen of an interface provided by the servers in relation to FIG. 5.

Beginning with FIG. 4, using client device 16, a user requests accesses to first server 22 (step 50). To do so, it is expected that the user will, using browser 40, browse to the network address assigned to first server 22. First server 22 receives and communicates the request to first responder 24, which then provides a first session interface that includes instructions to send association data, that is a client identifier and a session identifier, to association server 34 (step 52). It is expected that the first session interface will be a dynamically generated web page having a unique URL. First server 22 returns the session interface to client device 16 (step 54).

Client device 16 opens the first session interface (step 56) and accesses association server 34 sending association data (step 58). Where the first session interface is a web page, the instructions to send association data may be instructions to request a web bug from association server 34. A web bug is typically a small image, one pixel in size and is invisible to the user. The image itself usually does not serve a function. However, the request for the image does. When requesting the image, browser 40 sends a client identifier in the form of a cookie and the session identifier in the form of the URL of the web page provided in step 52 to association server 34. If browser 40 has never requested this particular web bug before, then the first access will create the cookie/identifier on client device 16 for the current and future requests. Upon receipt, association server 34 saves the association data, the cookie and the URL, in association table 36 (step 60).

Next, client device 16 requests access to second server 28 (step 62). This may be accomplished by manually browsing to a network address assigned to second server 28, first server 22 may redirect browser 40 to second server 28, or any other series of actions that result in browsing to second server 28 may be employed. Second server 28 receives and communicates the request to second responder 30, which then provides a desired session interface that includes instructions to send association data, that is a client identifier and a session identifier, to association server 34 (step 64). It is expected that the second session interface will be a dynamically generated web page having a unique URL. Second server 28 returns the session interface to client device 16 (step 66).

Client device 16 opens the second session interface (step 68) and accesses association server 34 sending association data (step 70). Where the second session interface is a web page, the instructions to send association data will be instructions to request a web bug from association server 34. When requesting the web bug, browser 40 sends the same client identifier (the same cookie) sent after opening the first session interface in step 56 to association server 34. Browser 40 also sends the session identifier, the URL of the web page provided in step 64, to association server 34. Upon receipt, association server 34 saves the association data, the cookie and URL as an entry 42 in association table 36 (step 72).

Second association service 32 queries association server 34 to identify the session identifier (URL) for the first session interface previously provided in step 52 (step 74). Second association service 32 provides association server 34 with the URL for the second session interface. Association server 34 passes the information to association table interface 38 which locates the entry 42 in association table 36 containing the provided URL and ascertains the client identifier (cookie) contained in that entry. Association table interface 38 then locates each other entry 42 in association table 36 that contains the ascertained client identifier. One of those entries 42 will contain the session identifier for the first session interface. For each located entry 42, association table interface 38 returns the session identifier to second association service 32. Second association service 32 identifies the session identifier for the first session interface and communicates that information to second responder 30 which then associates the session identifier of the second session interface with that of the first session interface. Second responder communicates with first server 22 to obtain information relating actions taken with regard to the first session interface (step 76). With this information second responder 30 can perform a specified task using the information obtained from first server 22 (step 78). A task as will be discussed with relation to the following example may include producing a selected electronic document. A task may involve performing a calculation using entered data. In fact, a task may be any action taken by a program.

FIGS. 5 and 6 help illustrate a specific implementation of the present invention in which first server 22 is used to select an electronic document such as a word processor file and the second server 28 is used to print or otherwise produce that document. In this example, it is assumed that servers 22, 28, and 34 are web servers. FIG. 5 is a flow chart illustrating steps taken to complete the process while FIG. 6 is an exemplary screen view of a session interfaces provided by servers 22 and 28.

Beginning with FIG. 5, using browser 40, a user requests access to first server 22, in this case a document server, browsing to the server's network address (step 80). First server 22 communicates the request to first responder 24, which generates a framed web page (step 82). A framed web page is one that divides the browser's display area into two or more sections or frames. The actual content of each frame is not provided by the framed web page itself. Rather, the framed web page provides, for each frame, a network address for accessing content to be displayed in that frame. Consequently, when browser 40 requests access to first server 22, first responder 24 provides a framed web page that includes a network address for retrieving content for the first frame to be provided by first responder 24 and a network address for retrieving content for the second frame to be provided by second responder 30. In this example, the content to be provided by the first responder 24 is a session interface for selecting and managing electronic documents. The documents may be stored anywhere that is accessible by first server 22. The content to be provided by second server 28 is a session interface for printing or otherwise producing a selected document, in this case a document selected using the session interface provided by first responder 24.

First server 22 returns the framed web page to browser 40 to be displayed on client device 16 (step 84). When displayed, browser 40 requests the content for the frames using the network addresses provided in the framed web page (step 86). In this example, the requests are directed to first and second servers 22 and 28. Servers 22 and 28 communicate the requests to responders 24 and 30 respectively. First responder 24 provides content—a web page having a unique URL—for the first frame and second responder 30 provides content—a web page having a unique URL—for the second frame. Each web page includes a request for a web bug from association server 34 (step 88). First and second servers 22 and 28 return the content to browser 40 to be displayed in the appropriate frames (step 90).

When displaying the content, browser 40 requests a web bug for each frame sending association data to association server 34 (step 92). The association data sent with relation to the first frame includes a cookie identifying browser 40 and the URL for the web page displayed in the first frame. Similarly, the association data sent with relation to the second frame includes the same cookie identifying browser 40 and the URL for the web page displayed in the second frame. Upon receipt of the association data, association server 34 saves the association data adding two entries 42 to association table 36 (step 94).

In the first frame, the user selects a document to be produced (step 96). In the second frame, the user selects the desired production controls (step 98). Second association service 32 queries association server 34 to identify the URL for the web page displayed in the first frame in order to identify the selected document (step 100). Second association service 32 provides association server 34 with the URL for the content displayed in the second frame. Association server 34 passes the information to association table interface 38 which locates the entry 42 in association table 36 containing the provided URL and ascertains the cookie contained in that entry 42. Association table interface 38 then locates each other entry 42 in association table 36 that contains the ascertained cookie. One of those entries 42 will contain the URL for the content displayed in the first frame. For each located entry 42, association table interface 38 returns the URL to second association service 32. Second association service 32 identifies the URL for the content displayed in the first frame and communicates that information to second responder 30.

Using the identified URL, second responder 30 communicates with first server 22 to identify the document selected by the user (step 102). Second responder 30 then produces the identified document according to the controls selected through the second frame (step 104).

FIG. 6 illustrates an example of a framed web page 110 displaying content for selecting and producing an electronic document. First responder 24 provides electronic document management services as illustrated by the content that first responder 24 provides in first frame 112. Second responder 30, in this example, provides document production services such as printing, e-mailing, and faxing as illustrated by the content that second responder 30 provides in second frame 114.

The content provided for the first frame 112 includes a scroll menu 116 displaying electronic documents accessible to first responder 24. In this example scroll menu 116 includes check boxes 118 allowing the user to select one or more of the displayed documents. Here, the document “catalog.doc” has been selected. Also included is pull down menu 120 and command buttons 122 and 124. Pull down menu 120 allows a user to select the type of documents displayed in scroll menu 116. In this example “all documents” is selected. A user may, however, desire to show only word processor documents or spreadsheets. Command buttons 122 and 124 allow a user to perform tasks such as deleting or renaming documents selected in scroll menu 116.

The content provided for second frame 114 includes controls 126-130 for printing, e-mailing, faxing, and archiving a document selected in first fame 112. Using controls 126, a user can instruct second responder 30 to print a document or documents selected in first frame 112. Using controls 128 or 130, the user can instruct second responder 30 to send the selected document to a particular e-mail address or fax the document to a particular number.

In a second implementation, the present invention is utilized not only to produce electronic documents but to identify a particular document management service responsible for managing the document to be produced. Initially a user registers with a document management service—second responder 30. More specifically, using browser 40 the user requests access to second server 28, a web server hosting a document management service, in this case second responder 30. Second server 28 receives and forwards the request to second responder 30 which generates a session interface—a web page—associating the user with a data store. Included in that web page are instructions to request a web bug from association server 34. Second server 28 returns the web page having a unique URL to browser 40. When displayed, browser 40 requests a web bug from association server 34 sending association data that includes a cookie identifying the user and the URL of the web page requesting the web bug. Association server 34 saves the association data as an entry in association table 34.

Later, the user requests access to first server 22, in this case a web server hosing a document production service, browsing to the server's network address. First server 22 communicates the request to first responder 24 (the production service), which generates a framed web page that includes a network addresses for retrieving content for two frames. In this example, the content to be provided by the first responder 24 for the first is a session interface for producing a selected document. The content for the second frame ultimately to be provided by second responder 30 is a session interface for selecting and otherwise managing electronic documents. The documents may be stored anywhere that is accessible by second responder 30.

First server 22 returns the framed web page to browser 40 to be displayed on client device 16. When displayed, browser 40 requests the content for the frames using the network addresses provided for each frame. In this example, the requests are both directed to first server 22. First server 22 receives and communicates the requests to first responder 24. First responder 24 provides production service content for the first frame. For the second frame, first responder 24 provides content—a web page having a unique URL that includes a request for a web bug from association server 34. First server 22 returns the content to browser 40 to be displayed in the appropriate frames.

When displaying the content in the second frame, browser 40 requests a web bug sending association data to association server 34. The association data sent includes a cookie identifying browser 40 and the URL for the web page displayed in the second frame. Upon receipt of the association data, association server 34 saves the association data adding an entry 42 to association table 36.

First association service 26 queries association server 34 to identify the document management service, in this case second responder 30. First association service 26 provides association server 34 with the URL for the content displayed in the second frame. Association server 34 passes the information to association table interface 38 which locates the entry 42 in association table 36 containing the provided URL and ascertains the cookie contained in that entry 42. Association table interface 38 then locates each other entry 42 in association table 36 that contains the ascertained cookie. As the user has registered with the document management service, one of those entries 42 will contain the URL associated with the document management service. For each located entry 42, association table interface 38 returns the URL to first association service 26. First association service 32 identifies the URL associated with a known document management service—second responder 30 in this instance—and communicates that URL to first responder 24.

Redirecting browser 40, first responder 24 then instructs browser 40 to access content for the second frame using the identified URL. Browser 40 responds requesting content from the identified URL. Second server 28 receives and forwards the request to second responder 30. Second responder 30 then provides content for the second frame—a web page for selecting and managing electronic documents in the user's data store. When the user, through content provided in the first frame, instructs first responder 24 to produce a document, first responder 24, using the identified URL, queries second responder to determine which, if any, documents have been selected. First responder 24 acquires and produces any selected documents according to the controls selected through the first frame.

It is not necessary to begin by filling the second frame with anything. The first frame could just as easily contain the web bug. First server 22 might delay serving the requested content for the second frame as browser 40 will wait some time before giving up on a request. After first server 22 uses the association server to find out who will serve pages for the second frame, first server can finally respond to the pending request for the second frame's content with a page that immediately forwards or redirects to browser 40 to the identified URL.

Although the flow charts of FIGS. 4 and 5 show a specific order of execution, the order of execution may differ from that which is depicted. For example, the order of execution of two or more blocks may be scrambled relative to the order shown. Also, two or more blocks shown in succession may be executed concurrently or with partial concurrence. All such variations are within the scope of the present invention. The screen display of FIG. 6 is exemplary only. There exist many possible layout and control configurations for interfaces that will allow a user to select and produce an electronic document. FIG. 6 merely provides one such example. While the above examples illustrate the coordination of two sessions, the present invention may be utilized to coordinate any number of sessions.

The present invention has been shown and described with reference to the foregoing exemplary embodiments. It is to be understood, however, that other forms, details, and embodiments may be made without departing from the spirit and scope of the invention which is defined in the following claims.

What is claimed is:

1. A method for coordinating sessions, comprising:
providing a session interface having instructions to send association data; and
identifying activity related to a previously provided session interface utilizing the association data.

2. The method of claim 1, further comprising performing a specified task in relation to the session interface in accordance with the identified activity.

3. The method of claim 1, wherein the first association data includes a client identifier and a session identifier associated with the session interface, and wherein the act of identifying comprises:
providing the session identifier associated with the session interface, identifying client identifier included in the association data;
identifying other association data containing that client identifier;
identifying the session identifier included in the other association data; and
identifying activity related to the previously provided session interface associated with the identified session identifier included in the other association data.

4. The method of claim 1, wherein the act of providing comprises providing a web page having instructions to request a web bug sending association data containing a cookie and an URL for the web page; and
wherein the act of identifying comprises:
providing the URL to identify the association data containing the cookie;
identifying other association data containing the cookie;
from the identified association data, Identifying a second URL for a previously provided web; and
identifying activity related to the previously provided web page utilizing the second URL.

5. A method for coordinating sessions, comprising:
providing a first session interface having instructions to send first association data;
sending the first association data;
providing a second session interface having instructions to send second association data;
sending the second association data; and
utilizing the first and second association data to identify activity related to the first session interface.

6. The method of claim 5, further comprising performing a specified task in relation to the second session interface in accordance with the identified activity.

7. The method of claim 5, wherein the first association data includes a client identifier and a first session identifier associated with the first session interface and the second association data includes the client identifier and a second session identifier associated with the second session interface, and wherein the acts of sending the first and second association data include adding the first association data as an entry to an association table and adding the second association data and an entry to the association table.

8. The method of claim 7, wherein the act of utilizing comprises:
identifying the client identifier in an entry in the association table containing the session identifier associated with the second session interface;
identifying other entries in the association table containing that client identifier;
identifying from those entries the session identifier associated with the first session interface; and
using the session identifier associated with the first session interface to identify activity related to the first session interface.

9. The method of claim 8, wherein the first session interface is a first web page, the second session interface is a second web page, the client identifier is a cookie, the session identifier associated with the first web page is an URL for that web page, and the session identifier associated with the second web page is an URL for the second web page, and wherein:
the act of identifying the client identifier comprises providing the URL for the second session interface and querying the association table for the cookie in an entry containing the provided URL;
the act of identifying other entries comprises identifying other entries containing the cookie;
the act of identifying from those entries comprises identifying the entry containing the URL for the first session interface; and
the act of using the session identifier, comprises using the URL for the first session interface to identify activity relating to the first session interface.

10. The method of claim 5, wherein the acts of providing the first and second session interfaces comprise providing a framed web page having a first frame for displaying the first session interface and a second frame for displaying the second session interface;
wherein the act of sending the first association data comprises sending a cookie and a first URL for the first session interface; and
wherein the act of sending the second association data comprises sending the cookie and a second URL for the second session interface.

11. The method of claim 10, further comprising saving the cookie and the first URL as one entry in an association table and saving the cookie and the second URL as another entry in the association table; and wherein the act of utilizing the first and second association data comprises:
providing the URL for the second session interface and querying the association table for the cookie in an entry containing the provided URL;
identifying other entries containing the cookie;
from those entries, identifying the entry containing the first URL; and
identifying activity relating to the first session interface using the first URL.

12. A session coordinating method, comprising:
providing a first web page having instructions to request a web bug;
requesting the web bug sending a cookie and an URL for the first web page;
providing a second web page having instructions to request the web bug;
requesting the web bug sending the cookie and an URL for the second web page;
saving the cookie and the URL for the first web page as an entry in an association table;
saving the cookie and the URL for the second web page as an entry in the association table;
providing the URL for the second web page, querying the association table for the cookie in the entry containing the URL for the second web page;
identifying other entries in the association table containing that cookie;
from those entries, identifying the entry containing the URL for the first web page; and
identifying activity relating to the first web page using that URL.

13. A computer readable medium having instructions for:
providing a session interface having instructions to send association data; and
identifying activity related to a previously provided session interface utilizing the association data.

14. The medium of claim 13, having further instructions for performing a specified task in relation to the session interface in accordance with the identified activity.

15. The medium of claim 13, wherein the first association data includes a client identifier and a session identifier associated with the session interface, and wherein the instructions for identifying comprise instructions for:
providing the session identifier associated with the session interface, identifying client identifier included in the association data;
identifying other association data containing that client identifier;
identifying the session identifier included in the other association data; and
identifying activity related to the previously provided session interface associated with the identified session identifier included in the other association data.

16. The medium of claim 13, wherein the instructions for providing comprise instructions for providing a web page having instructions to request a web bug sending association data containing a cookie and an URL for the web page; and
wherein the instructions for identifying comprise instructions for:
providing the URL to identify the association data containing the cookie;
identifying other association data containing the cookie;
from the identified association data, identifying a second URL for a previously provided web page; and
identifying activity related to the previously provided web page utilizing the second URL.

17. A computer readable medium having instructions for:
providing a first session interface having instructions to send first association data;
providing a second session interface having instructions to send second association data; and
identifying activity related to the first session interface utilizing the first and second association data.

18. The medium of claim 17, having further instructions for performing a specified task in relation to the second session interface in accordance with the identified activity.

19. The medium of claim 17, wherein the first association data includes a client identifier and a first session identifier associated with the first session interface and the second association data includes the client identifier and a second session identifier associated with the second session interface, the medium having further instructions for adding the first association data, once sent, as an entry to an association table and adding the second association data, once sent, as an entry to the association table.

20. The medium of claim 19, wherein the instructions for identifying comprise:
identifying the client identifier in an entry in the association table containing the session identifier associated with the second session interface;
identifying other entries in the association table containing that client identifier;
identifying from those entries the session identifier associated with the first session interface; and
identifying activity related to the first session interface using the session identifier associated with the first session interface.

21. The medium of claim 20, wherein the first session interface is a first web page, the second session interface is a second web page, the client identifier is a cookie, the session identifier associated with the first web page is an URL for that web page, and the session identifier associated with the second web page is an URL for the second web page, and wherein:
the instructions for identifying the client identifier comprise instructions for providing the URL for the second session interface and querying the association table for the cookie in an entry containing the provided URL;
the instructions for identifying other entries comprise instructions for identifying other entries containing the cookie;
the instructions for identifying from those entries comprise instructions for identifying the entry containing the URL for the first session interface; and
the act of identifying activity comprises identifying activity relating to the first session interface using the URL for the first session interface.

22. The medium of claim 17, wherein the instructions for providing the first and second session interfaces comprise instructions for providing a framed web page having a first frame for displaying the first session interface and a second frame for displaying the second session interface; and
wherein the first association data includes a cookie and a first URL for the first session interface and the second association data includes the cookie and a second URL for the second session interface.

23. The medium of claim 22, having further instructions for saving the cookie and the first URL as one entry in an association table and saving the cookie and the second URL as another entry in the association table; and wherein the instructions for identifying activity comprise instructions for:
providing the URL for the second session interface and querying the association table for the cookie in an entry containing the provided URL;
identifying other entries containing the cookie;
from those entries, identifying the entry containing the first URL; and
identifying activity relating to the first session interface using the first URL.

24. A computer readable medium having instructions for:
providing a first web page having instructions to request a web bug sending a cookie and an URL for the first web page;
providing a second web page having instructions to request the web bug sending the cookie and an URL for the second web page;
saving the cookie and the URL for the first web page as an entry in an association table;
saving the cookie and the URL for the second web page as an entry in the association table;
providing the URL for the second web page, querying the association table for the cookie in the entry containing the URL for the second web page;
identifying other entries in the association table containing that cookie;
from those entries, identifying the entry containing the URL for the first web page; and
identifying activity relating to the first web page using that URL.

25. A system for coordinating sessions, comprising:
a responder operable to provide a session interface having instructions to send association data containing a client identifier and a session identifier for the session interface;
an association server operable to receive the association data, save the association data in an association table, and receive queries for the association table;
an association table interface in communication with the association server and operable access and provide association data from the association table according to a received query; and
an association service in communication with the responder and the association server and operable to provide the session identifier and to query the association server for a session identifier for a previously provided session interface.

26. The system of claim 25, wherein:
the responder is further operable to provide the session interface in the form of a web page;
the client identifier is a cookie and the session identifier is an URL for the web page;
the association server is further operable to save the cookie and the URL, when received, as an entry in the association table;
the association service is further operable to provide the URL and query the association service for a second URL for a previously provided web page; and
the association table interface is further operable to identify the entry in the association table containing the provided URL, identify the cookie in that entry, locate another entry containing the same cookie, and return the URL from that located entry to the association service.

27. A system for coordinating sessions, comprising:
a first responder operable to provide a first session interface having instructions to send association data containing a client identifier and a first session identifier for the first session interface;
a second responder operable to provide a second session interface having instructions to send association data containing the client identifier and a second session identifier for the second session interface;
an association server operable to receive the association data, save the association data in an association table, and receive queries for the association table;
an association table interface in communication with the association server and operable to access and provide association data from the association table according to a received query; and
an association service in communication with the second responder and the association server and operable to provide the session identifier and to query the association server for a session identifier for the first session interface.

28. The system of claim 27, wherein:
the first responder is further operable to provide the first session interface in the form of a first web page;
the second responder is further operable to provide the second session interface in the form of a second web page;
the client identifier is a cookie, the first session identifier is a first URL for the first web page, and the second session identifier is a second URL for the second web page;
the association server is further operable to save the cookie and the first URL, when received, as an entry in the association table and save the cookie and the second URL, when received, as another entry in the association table;
the association service is further operable to provide the second URL and query the association service for the first URL;
the association table interface is further operable to identify the entry in the association table containing the second URL, identify the cookie in that entry, locate another entry containing the same cookie, and return the first URL from that located entry to the association service.

29. A system for coordinating sessions, comprising:
a first responder operable to provide a first web page having instructions to send association data containing a cookie and a first URL for the first web page;
a first server operable to serve the first web page;
a second responder operable to provide a second web page having instructions to send association data containing the cookie and a second URL for the second session web page;
a second server operable to serve the second web page;
a client operable to request the first and second web pages from the first and second servers, display the first and second web pages, send the cookie and first URL upon displaying the first web page, and send the cookie and the second URL upon displaying the second web page;
an association server operable to receive the cookie and the first URL saving the pair as an entry in an association table and to receive the cookie and the second URL saving the pair as an another entry in the association table;
an association service in communication with the second responder and the association server and operable to provide the first URL and to query the association server for the second URL; and
an association table interface in communication with the association server and operable to identify the entry in the association table containing the second URL, identify the cookie in that entry, locate another entry containing the same cookie, and return the first URL from that located entry to the association service.

30. A system for coordinating sessions, comprising:
a means for providing a session interface having instructions to send association data containing a client identifier and a session identifier for the session interface;
a means for receiving association data, saving the association data in an association table, and receiving queries for the association table;
a means for accessing and providing association data from the association table according to a received query; and
a means for providing the session identifier and a query for a session identifier for a previously provided session interface.
